(19) United States
(12) Patent Application Publication
(10) Pub. No.: US 2022/0298314 A1
(43) Pub. Date: Sep. 22, 2022

(54) POLYOLEFIN MICROPOROUS FILM, LAYERED BODY, AND BATTERY

(71) Applicant: TORAY INDUSTRIES, INC., Tokyo (JP)

(72) Inventors: Hiroko TANAKA, Tochigi (JP); Naoya NISHIMURA, Tochigi (JP); Haruka SHIMOKAWATOKO, Tochigi (JP); Takuya KUMA, Tochigi (JP)

(73) Assignee: TORAY INDUSTRIES, INC., Tokyo (JP)

(21) Appl. No.: 17/636,130

(22) PCT Filed: Aug. 19, 2020
(86) PCT No.: PCT/JP2020/031351

§ 371 Date: Feb. 17, 2022

(30) Foreign Application Priority Data
Aug. 22, 2019 (JP) 2019-152105

(51) Int. Cl. C08J 5/18; C08J 9/26

(52) U.S. Cl. CPC C08J 5/18; C08J 9/26; C08J 2323/06; C08J 2323/12

(57) ABSTRACT

A polyolefin microporous film includes: a polyethylene-based resin; and a polyolefin (B) other than polyethylene. The polyolefin microporous film has peaks at temperatures of lower than 150° C. and 150° C. or higher respectively in a differential scanning calorimeter (DSC). A half width of the peak at lower than 150° C. is 10° C. or lower. A puncture strength in terms of 10 μm is 2.0 N or more.

### TECHNICAL FIELD

The present invention relates to a polyolefin microporous film and a laminate which are excellent in safety and output characteristics when used as a battery separator, and a battery using the same.

### BACKGROUND ART

Polyolefin microporous films are used as filters, separators for fuel cells, separators for capacitors, and the like. In particular, the separator is suitably used as a separator for lithium ion batteries widely used in notebook personal computers, mobile phones, digital cameras, and the like. The reason for this is that the polyolefin microporous film has excellent mechanical strength and shutdown characteristics. In particular, in recent years, lithium ion secondary batteries have been developed for the purpose of increasing an energy density, a capacity, and output mainly for in-vehicle applications. Along with this, characteristics required for safety of the separator have become even higher.

In order to prevent an accident such as ignition when the inside of the battery is overheated in an overcharged state, the separator needs to have a function (shutdown function) of blocking a current by being melted to clog holes, and the temperature (shutdown temperature) at which the shutdown function is exhibited is preferably low. In addition, even after the shutdown, the temperature inside the battery continues to rise at that moment. Therefore, at a temperature equal to or higher than the shutdown temperature, the separator is required to maintain a shape of the separator itself and prevent the short circuit of the electrode, and a film breaking temperature (meltdown temperature) of the separator is preferably high. Therefore, it is necessary to achieve both low-shutdown and high-meltdown characteristics, and it can be said that the larger the temperature difference between the shutdown temperature and the meltdown temperature, the higher the safety. One of methods of lowering the shutdown temperature is lowering a melting point of a raw material by lowering a molecular weight of the material constituting the separator, and one of methods of increasing the meltdown temperature is adding a polyolefin having a high melting point such as polypropylene. In addition, for the shutdown function, it is necessary to quickly shut off the current in terms of safety, and the shutdown speed is also an important characteristic.

On the other hand, with an increase in a capacity of a battery, a thickness of a separator tends to be reduced, and an increase in the strength of the separator is required in order to prevent a short circuit during winding or due to a foreign substance and the like in the battery. In general, examples of methods of increasing the strength of the separator include a method of controlling a crystal orientation of the polyolefin by stretching at a high ratio and a method of increasing the molecular weight of the raw material. However, when the crystal is highly oriented, the melting point is increased and the shutdown temperature is also increased, and therefore, the increase in strength and the decrease in shutdown temperature are trade-off.

Patent Literature 1 provides a polyolefin microporous film having a low thermal shrinkage ratio, excellent film breakage resistance, and small variation in film thickness by using polyethylene and polypropylene having a high terminal vinyl group concentration in combination.

In Patent Literature 2, meltdown characteristics are improved by adding a high molecular weight compound of polypropylene.

Patent Literature 3 proposes a separator excellent in safety by adding a high molecular weight polypropylene to improve meltdown characteristics and increase a temperature difference between a shutdown temperature and a meltdown temperature. In addition, by using ultra high molecular weight polyethylene in combination, a low thermal shrinkage ratio at high temperature is achieved, and in Example 17, a high-strength film having a thin film thickness of 3.2 μm but having a puncture strength of 200 gf is obtained.

### CITATION LIST

### Patent Literature

Patent Literature 1: WO 2007/051416
Patent Literature 2: JP-A-2005-200578
Patent Literature 3: WO 2015/166878

### SUMMARY OF INVENTION

### Technical Problem

However, Patent Literature 1 does not pay attention to the melting point and the shutdown characteristics of polyethylene to be used, and the shutdown temperature of the obtained film exceeds 135° C. Further, as a method of lowering the shutdown temperature, a component having a molecular weight of 1000 or less is contained in a certain amount or more, and the molecular weight distribution of the polyolefin microporous film is very wide. When the molecular weight distribution is wide as described above, the melting point peak is broad, and thus the shutdown speed is slow.

In the polyolefin microporous film described in Patent Literature 2, since the crystal is highly oriented by stretching using linear polyethylene as a main component, the shutdown temperature exceeds 135° C., and there is room for improvement in terms of safety.

The separator described in Patent Literature 3 is stretched at a high ratio in order to achieve a high strength, the shutdown temperature is increased to 138° C., and the temperature difference from the meltdown temperature is relatively small. Further, since linear high-density polyethylene is used, it is considered that a high melting point component is generated as the orientation of the crystal progresses by stretching. In such a case, even when the shutdown is started from a low temperature, since the high melting point component is present, it is considered that it takes time to complete the shutdown.

As described above, there is room for improvement in the development of a separator having high safety without impairing the battery performance with respect to the needs of customers that diversify along with an increase in energy density, an increase in capacity, and an increase in output.

An object of the present invention is to solve the above-described problems. That is, an object of the present invention is to provide a polyolefin microporous film excellent in safety and output characteristics when used as a battery separator.

### Solution to Problem

In order to solve the above-described problems and achieve the object, the present invention has the following configurations.

[1] A polyolefin microporous film including: a polyethylene-based resin; and a polyolefin (B) other than polyethylene, in which: the polyolefin microporous film has peaks at temperatures of lower than 150° C. and 150° C. or higher respectively in a differential scanning calorimeter (DSC); a half width of the peak at lower than 150° C. is 10° C. or lower; and a puncture strength in terms of 10 μm is 2.0 N or more.
[2] The polyolefin microporous film according to [1], in which the polyolefin microporous film further has a peak at 135° C. or lower in DSC.

[3] The polyolefin microporous film according to [1] or [2], in which the polyolefin microporous film is a single layer.

[4] The polyolefin microporous film according to any one of [1] to [3], in which a content of the polyolefin (B) other than polyethylene is 10% by mass or more.

[5] The polyolefin microporous film according to any one of [1] to [4], in which the polyolefin (B) other than polyethylene is a polypropylene-based resin.

[6] The polyolefin microporous film according to any one of [1] to [5], in which a shutdown temperature is 135° C. or lower.
[7] The polyolefin microporous film according to any one of [1] to [6], in which a meltdown temperature is 160° C. or higher.

[8] The polyolefin microporous film according to any one of [1] to [7], in which the polyolefin microporous film has a film thickness of 10 μm or less.

[9] The polyolefin microporous film according to any one of [1] to [8], in which the polyolefin microporous film has a peak at 120° C. or higher in the differential scanning calorimeter (DSC).
[10] A laminate, in which a coating layer is provided on at least one surface of the polyolefin microporous film according to any one of [1] to [9].
[11] A battery using the polyolefin microporous film according to any one of [1] to [9] or the laminate according to [10].

### Advantageous Effects of Invention

A polyolefin microporous film of the present invention has high safety and excellent output characteristics with low shutdown characteristics and high meltdown characteristics when used as a battery separator, while having a high strength. Therefore, the polyolefin microporous film can be suitably used as a battery separator or a laminate for a battery and a secondary battery requiring a high energy density, a high capacity, and high output for an electric vehicle and the like.

### DESCRIPTION OF EMBODIMENTS

A polyolefin microporous film according to an embodiment of the present invention contains a polyethylene-based resin and a polyolefin (B) other than polyethylene. The polyolefin microporous film has peaks at temperatures of lower than 150° C. and 150° C. or higher respectively in DSC.

A half width of the peak at temperatures of lower than 150° C. is 10° C. or lower.

A puncture strength in terms of 10 μm is 2.0 N or more.

One of the features of the polyolefin microporous film according to the embodiment of the present invention (hereinafter, sometimes simply referred to as “microporous film”) is that the polyolefin microporous film has peaks at temperatures of lower than 150° C. and 150° C. or higher respectively when heated by a differential scanning calorimeter (DSC) in accordance with JIS K 7121. The term “has peaks” as used herein means that the result obtained by DSC has a maximum value when a horizontal axis represents a temperature and a vertical axis represents heat flow. The feature of the polyolefin microporous film in the embodiment of the present invention is that the temperatures at which a maximum value is obtained exist in the temperatures of lower than 150° C. and 150° C. or higher respectively.

In addition, the temperature of the peak at lower than 150° C. is preferably 140° C. or lower, and more preferably 135° C. or lower. In terms of a lower limit, the temperature is 120° C. or higher, and preferably 123° C. or higher. When the temperature is higher than the above range, the shutdown temperature increases when used as a separator of a battery, which is not preferable. In addition, when the temperature of lower than 150° C. at which the peak is maximized is lower than the above range, the shrinkage ratio at a high temperature is high, and electrodes come into contact with each other in the battery to cause a short circuit, which is not preferable.

Further, in the polyolefin microporous film according to the embodiment of the present invention, the half width of the peak at temperatures of lower than 150° C. needs to be at 10° C. or lower, preferably 10.0° C. or lower, more preferably 9.5° C. or lower, still more preferably 9.3° C. or lower, particularly preferably 9.1° C. or lower, and most preferably 9.0° C. or lower. The smaller the half width is, the more easily the resin is melted at once at a certain temperature when the polyolefin microporous film is used as a separator of a battery. Since the shutdown speed increases and the safety of the battery is improved, it is preferable that the half width is small. Here, the half width of the peak means a value of T₂−T₁ when the temperatures at which a heat generation amount is Q_{1/2}, which is 0.5 times a maximum heat generation amount Q in the region of lower than 150° C., are set to T₁ and T₂ (T₁<T₂), respectively. In the case where there are two or more maximum values in the region of lower than 150° C. and thus there are three or more temperatures at which the heat generation amount is Q_{1/2}, a half width is calculated with the minimum temperature of the corresponding temperatures as T₁ and the maximum temperature as T₂. In order to set the half width within the above range, it is preferable that the raw material composition of the film is set within a range described later, and stretching conditions and heat fixing conditions during film formation are set within a range described later.

Typically, lowering the shutdown temperature has been achieved by adding a low melting point polymer that melts at a low temperature to a raw material. However, since the low melting point polymer has low crystallinity, pore openings in the stretching process are insufficient, the porosity of the obtained porous film tends to decrease and the strength tends to decrease, and it was difficult to achieve both the output characteristics and safety of the battery. In order to further increase the strength, a method of stretching at a high ratio can be considered, but when the ratio is increased, a crystal of polyolefin other than the low melting point polymer which is a main component is oriented, and the melting point is increased, such that the shutdown temperature is increased, and it was difficult to achieve both the high strength and the low temperature shutdown. Further, the high stretching ratio advances the crystal orientation of the polyolefin to generate a high melting point component, and in particular, the peak at a high temperature side of the DSC chart is broad. Therefore, in general, the half width is increased, which leads to a decrease in the shutdown speed.

The film thickness of the polyolefin microporous film according to the embodiment of the present invention is appropriately adjusted depending on the application, and is not particularly limited. However, in order to increase the capacity of the battery, a thin film is preferable. In terms of the lower limit, the film thickness is preferably 2 μm or more, and more preferably 3 μm or more. In addition, in terms of the upper limit, the film thickness is preferably 15 μm or less, more preferably 12 μm or less, still more preferably 10 μm or less, and particularly preferably 8 μm or less. When the film thickness exceeds 15 μm, sufficient output characteristics and energy density may not be obtained when the film is used as a separator for a high-capacity battery in the future. From the above viewpoint, the thinner the film thickness is, the more preferable. However, the lower limit of the film thickness is about 2 μm because safety may be reduced or handling may be difficult. The film thickness can be adjusted by a discharge amount of an extruder, a film formation rate, a stretching ratio, a stretching temperature, and the like within a range in which other physical properties are not deteriorated.

In addition, the porosity of the polyolefin microporous film according to the embodiment of the present invention is preferably 30% or more, more preferably 35% or more, and still more preferably 40% or more. In addition, the upper limit is preferably 70% or less, more preferably 65% or less, and still more preferably 60% or less. The porosity is preferably 30% or more because in the case where the porosity is lower than the above range, when the polyolefin microporous film is used as a separator of a battery, ion permeability is insufficient and the output characteristics of the battery deteriorate. In addition, when the porosity is higher than the above range, the strength decreases, and a short circuit is likely to occur during winding or due to a foreign substance and the like in the battery, and therefore, the porosity is preferably 70% or less. In order to set the porosity within the above range, it is preferable that the raw material composition of the film is set within a range described later, and stretching conditions and heat fixing conditions during film formation are set within a range described later.

In the polyolefin microporous film according to the embodiment of the present invention, the puncture strength of the film converted in terms of a film thickness of 10 μm needs to be 2.0 N or more, preferably 2.5 N or more, more preferably 2.8 N or more, still more preferably 3.0 N or more, yet still more preferably 3.3 N or more, particularly preferably 3.5 N or more, and most preferably 3.8 N or more. When the puncture strength is less than 2.0 N, a short circuit may occur during winding or due to a foreign substance and the like in the battery, and the safety of the battery may be reduced. From the viewpoint of the safety of the battery, when the puncture strength is 2.0 N or more, the strength can be increased.

However, in many cases, the increase in the puncture strength and the decrease in the shutdown temperature are trade-off, and the upper limit is 15 N. In order to set the puncture strength to the above range, it is preferable that the raw material composition of the film is set within a range described later, and the stretching conditions during film formation are set within a range described later. In general, the strength can be increased by increasing the stretching ratio.

In the polyolefin microporous film according to the embodiment of the present invention, an air permeability resistance of the film converted in terms of a film thickness of 10 μm is preferably 100 seconds/100 cm³ or more and 2000 seconds/100 cm³ or less. The air permeability resistance is more preferably 100 seconds/100 cm³ or more and 600 seconds/100 cm³ or less, still more preferably 100 seconds/100 cm³ or more and 400 seconds/100 cm³ or less, and most preferably 140 seconds/100 cm³ or more and 400 seconds/100 cm³ or less. In the case where the air permeability resistance is less than 100 seconds/100 cm³, the strength of the film may be lowered and the handling property may be lowered when the film is used as a thin film separator, or a fine short circuit due to dendrite may be likely to occur when the film is used as a separator for a high-output battery. In the case where the air permeability resistance exceeds 2000 seconds/100 cm³, when the film is used as a battery separator, the ion permeability is insufficient, and the output characteristics of the battery may be deteriorated. In order to set the air permeability resistance within the above range, it is preferable that the raw material composition of the film is set within a range described later, and stretching conditions during film formation are set within a range described later.

In the polyolefin microporous film according to the embodiment of the present invention, when a tensile strength in a machine direction of the film is M_{MD} and a tensile strength in a transverse direction of the film is M_{TD}, both of M_{MD} and M_{TD} are preferably 80 MPa or more. The tensile strength is more preferably 90 MPa or more, still more preferably 100 MPa or more, most preferably 110 MPa or more, and particularly preferably 150 MPa or more. When the tensile strength is less than 90 MPa, a short circuit is likely to occur during winding or due to a foreign substance and the like in the battery when the thin film is formed, and the safety of the battery may be reduced. From the viewpoint of improving the safety, it is preferable that the tensile strength is high, but the lowering of the shutdown temperature and the improvement of the tensile strength are often trade-off, and the upper limit is about 200 MPa. In order to set the tensile strength within the above range, it is preferable that the raw material composition of the film is set within a range described later and the stretching conditions during film formation are set within a range described later, so that the tensile strength falls within the above range, and an increase in the peak temperature and an increase in the half width in DSC can be prevented.

In the embodiment of the present invention, a direction parallel to a direction of film formation is referred to as a film forming direction, a machine direction, or an MD direction, and a direction orthogonal to the film forming direction in a film plane is referred to as a transverse direction or a TD direction.

A tensile elongation in the MD direction (tensile elongation at break) and a tensile elongation in the TD direction of the polyolefin microporous film are not particularly limited, but are, for example, 40% or more and 300% or less, preferably 50% or more and 200% or less, preferably 60% or more and 200% or less, and more preferably 70% or more and 150% or less. When the elongation at break in the MD direction is within the above range, even when a high tension is applied during coating, deformation is less likely to occur and wrinkles are less likely to occur, so that the occurrence of coating defects is prevented and the planarity of the coating surface is good, which is preferable.

The tensile elongation (tensile elongation at break) of the polyolefin microporous film in the TD direction is preferably 60% or more, and more preferably 70% or more.

When the elongation at break in the TD direction is within the above range, the impact resistance that can be evaluated by an impact test and the like is excellent, and when the polyolefin microporous film is used as a separator, the separator can follow the unevenness of the electrode, the deformation of the battery, the generation of an internal stress due to heat generation of the battery, and the like, which is preferable.

The MD tensile elongation and the TD tensile elongation are values measured by a method in accordance with ASTM D882.

The polyolefin microporous film according to the embodiment of the present invention preferably has a shutdown temperature of 135° C. or lower. The shutdown temperature is more preferably 133° C. or lower, still more preferably 130° C. or lower, and most preferably 128° C. or lower. When the shutdown temperature is 135° C. or lower, the safety is improved when the polyolefin microporous film is used as a battery separator for a secondary battery requiring a high energy density, a high capacity, and high output for an electric vehicle and the like. From the viewpoint of safety, the shutdown temperature is preferably low, but when the shutdown temperature is 80° C. or lower, holes are closed even in a normal use environment and the battery characteristics deteriorate, and therefore, the lower limit of the shutdown temperature is about 80° C. In order to set the shutdown temperature to the above range, it is preferable that the raw material composition of the film is set within a range described later, the stretching ratio during film formation is set to 25 times to 100 times, and the heat fixing temperature is set within the range of 70° C. to 135° C.

In the embodiment of the present invention, a specific polyethylene-based resin to be described later is used as a raw material, the raw material composition is set within a range described later, and the stretching conditions and the heat fixing conditions during film formation are set within a range described later, thereby achieving both the high strength and low temperature shutdown without lowering the shutdown speed.

The polyolefin microporous film according to the embodiment of the present invention preferably has a meltdown temperature of 160° C. or higher. The meltdown temperature is more preferably 162° C. or higher, still more preferably 165° C. or higher, and most preferably 168° C. or higher. In the case where the meltdown temperature is 160° C. or higher, the safety is improved when the polyolefin microporous film is used as a battery separator for a secondary battery requiring a high energy density, a high capacity, and high output for an electric vehicle and the like. From the viewpoint of safety, the meltdown temperature is preferably high, but from the viewpoint of balance with other characteristics, the upper limit is about 250° C. In order to set the meltdown temperature to the above range, it is preferable that the raw material composition of the film is set within a range described later, and stretching conditions and heat fixing conditions during film formation are set within a range described later.

The polyolefin microporous film in the embodiment of the present invention is preferably a single layer. The term “single layer” as used herein refers to a structure in which layers that are different in compositions, used raw materials, or physical properties from each other are not arranged in a film thickness direction of the polyolefin microporous film. In the case of a single layer, as compared with a laminate in which two or more layers that are different in compositions, used raw materials, or physical properties from each other are arranged in the film thickness direction of the polyolefin microporous film, not only the manufacturing process is simplified, but also the film thickness can be reduced. Therefore, the single layer is preferable.

Generally, in order to achieve both the shutdown characteristics and the meltdown characteristics, a method of laminating a layer that lowers the temperature of shutdown and a layer that increases the temperature of meltdown is generally used. However, in a microporous film having a thin film thickness which is required in the future, since the film thickness of each layer becomes too thin when the microporous film is laminated, it is difficult to express the characteristics of each layer, or the thickness unevenness or the lamination unevenness becomes large, and the variation in physical properties may be large. On the other hand, in order to achieve both the shutdown characteristics and the meltdown characteristics in a single-layer microporous film, it is necessary to uniformly knead raw materials having different characteristics. However, in the related art, it was difficult to perform uniform kneading, and further, in a thin film, non-uniformity of kneading becomes more remarkable, and therefore it was difficult to obtain a thin film which is a single-layer microporous film having both excellent shutdown characteristics and meltdown characteristics.

The polyolefin microporous film according to the embodiment of the present invention preferably has an average pore diameter of 50 nm or less. The average pore diameter is more preferably 40 nm or less, still more preferably 30 nm or less, and most preferably 25 nm or less. When the average pore diameter is within the above preferable range, it is preferable because the resistance to dendrite can be improved and the internal short circuit can be prevented. From the above viewpoint, the smaller the average pore diameter is, the more preferable the polyolefin microporous film is. However, when the average pore diameter is too small, the ion permeability is insufficient, and the output characteristics of the battery may deteriorate, and thus the lower limit is about 10 nm. In order to set the average pore diameter to the above range, it is preferable to use at least a high molecular weight compound and a polyolefin (B) described later as raw materials of the film, and to set the stretching ratio during film formation to a range of 25 to 100 times.

In the polyolefin microporous film according to the embodiment of the present invention, the ratio of the average pore diameter to the maximum pore diameter (average pore diameter/maximum pore diameter) is preferably 0.7 to 1.0. The ratio is more preferably 0.72 to 1.0, still more preferably 0.75 to 1.0, and most preferably 0.8 to 1.0. When the ratio of (average pore diameter/maximum pore diameter) is 0.7 or more, the uniformity of the pore diameter is high, and therefore, even when the film is used as a thin-film high-output battery separator, it is possible to prevent a fine short circuit due to dendrite. The upper limit is 1.0 in terms of the measurement principle. In order to set the (average pore diameter/maximum pore diameter) within the above range, it is preferable that the raw material composition of the film is set within a range described later, and stretching conditions during film formation are set within a range described later.

Next, the raw material of the polyolefin microporous film according to the embodiment of the present invention will be described, but the present invention is not necessarily limited thereto.

The polyolefin microporous film according to the embodiment of the present invention is a film containing a polyolefin resin as a main component. Here, in the present invention, the term “main component” means that the proportion of a specific component in all components is 50% by mass or more, more preferably 90% by mass or more, still more preferably 95% by mass or more, and most preferably 99% by mass or more.

The polyolefin resin used in the embodiment of the present invention may be a polyolefin composition. Examples of the polyolefin resin include polyethylene-based resins and polypropylene-based resins, and two or more of these may be blended and used.

The polyolefin microporous film according to the embodiment of the present invention preferably contains the polyethylene-based resin as a main component. The term “polyethylene-based resin” as used herein includes not only a homopolymer of ethylene but also a copolymer obtained by copolymerizing other monomers.

The polyolefin microporous film according to the embodiment of the present invention contains a polyethylene-based resin and a polyolefin (B) other than polyethylene. First, the polyethylene-based resin will be described.

As described above, the polyethylene-based resin includes not only a homopolymer of ethylene but also a copolymer obtained by copolymerizing other monomers. Various polyethylenes can be used, and examples thereof include ultra high molecular weight polyethylene, high-density polyethylene, medium-density polyethylene, and low-density polyethylene.

The copolymer obtained by copolymerizing other monomers is preferably a copolymer containing other α-olefin in order to reduce the melting point and crystallinity of the raw material. Examples of the α-olefin include propylene, butene-1, hexene-1, pentene-1, 4-methylpentene-1, octene, vinyl acetate, methyl methacrylate, and styrene. The copolymer containing the α-olefin (ethylene-α-olefin copolymer) is preferably a copolymer containing hexene-1, and more preferably a copolymer containing an ethylene-1-hexene copolymer as a main component. In addition, the α-olefin can be confirmed by measurement with C¹³-NMR.

Since the polyethylene-based resin has excellent melt extrusion characteristics and excellent uniform stretching characteristics, it is preferable to use high-density polyethylene (polyethylene having a density of 0.920 g/cm³ or more and 0.970 g/cm³ or less) as a main component.

The high-density polyethylene includes linear high-density polyethylene and branched high-density polyethylene, and it is particularly preferable to include branched high-density polyethylene (branched HDPE). The branched high-density polyethylene is more preferable because the in-plane crystal orientation is less likely to proceed, the change in the crystal structure can be reduced, and the shutdown temperature can be lowered. Furthermore, even when the stretching ratio is increased, the crystal orientation is less likely to proceed, and the generation of the high melting point component can be prevented, and thus an increase in the half width of the peak in DSC can also be prevented. As a result, it is possible to realize a high strength and thin film formation by high stretching ratio while maintaining the shutdown speed.

In addition, the melting point of the high-density polyethylene is preferably 130° C. or higher, and more preferably 135° C. or lower. When the melting point is 130° C. or higher, a decrease in the porosity can be prevented, and when the melting point is 135° C. or lower, an increase in the shutdown temperature can be prevented.

That is, the polyolefin resin in the embodiment of the present invention or the polyolefin resin used for the purpose of lowering the shutdown temperature is particularly preferably polyethylene having a Mw of 1.0×10⁵ to 1.0×10⁶ and a melting point of 130° C. to 135° C. The polyethylene is preferably contained in an amount of 50% by mass or more when the total amount of the polyolefin resin is taken as 100% by mass.

In addition, when a low molecular weight polyethylene such as a low-density polyethylene, a linear low-density polyethylene, an ethylene-α-olefin copolymer manufactured with a single-site catalyst, or a low molecular weight polyethylene having a weight average molecular weight of 1,000 to 100,000 is added to the polyethylene-based resin, a shutdown function at a low temperature is imparted, and the characteristics as a battery separator can be improved. However, when the content of the low molecular weight polyethylene in the polyethylene-based resin is large, the porosity of the microporous film decreases in the film forming step, and thus the content of the low molecular weight polyethylene is preferably adjusted such that the density of the ethylene-α-olefin copolymer exceeds 0.94 g/cm³, and it is more preferable to adjust the density by adding a branched high-density polyethylene having a long chain branched component.

In addition, from the above viewpoint, in a molecular weight distribution of a polymer constituting the polyolefin microporous film according to the embodiment of the present invention, a component amount having a molecular weight of less than 40,000 is preferably less than 20%. The component amount having a molecular weight of less than 20,000 is more preferably less than 20%, and the component amount having a molecular weight of less than 10,000 is still more preferably less than 20%.

In addition, the polyolefin microporous film according to the embodiment of the present invention contains the polyolefin (B) other than polyethylene for the purpose of improving the meltdown characteristics. The polyolefin (B) is not particularly limited, and a polypropylene-based resin, a polymethylpentene-based resin, a polybutene-based resin, a polyacetal-based resin, a styrene-based resin, a polyphenylene ether-based resin, and the like can be used. Among these, a polypropylene-based resin is preferable from the viewpoint of kneading properties and electrical stability when used as a separator. As the kind of the polypropylene-based resin, a block copolymer or a random copolymer can be used in addition to a homopolymer of propylene. The block copolymer and the random copolymer may contain a copolymer component with α-ethylene other than propylene, and the other α-ethylene is preferably ethylene.

In terms of the upper limit, the content of the polyolefin (B) in the polyolefin microporous film is preferably 40% by mass or less, and more preferably 35% by mass or less, based on the total mass of the polyolefin microporous film. In addition, in terms of the lower limit, the content of the polyolefin (B) is preferably 5% by mass or more, more preferably 10% by mass or more, still more preferably 15% by mass or more, particularly preferably 20% by mass or more, and most preferably 22% by mass or more. When the content of the polyolefin (B) is 40% by mass or less, the pore diameter of the microporous film is large, sufficient permeability is obtained, the strength is excellent, and an increase in the shutdown temperature can be prevented. In addition, when the content is 5% by mass or more, the polyolefin (B) has a co-continuous structure with the polyolefin resin as the main component, and the effect of improving the meltdown temperature by the polyolefin (B) is easily exhibited.

In addition, the melting point of the polyolefin (B) to be added is preferably 150° C. or higher, more preferably 155° C. or higher, and still more preferably 160° C. or higher.

Furthermore, for the molecular weight of the polyolefin (B), the weight average molecular weight is preferably 5.0×10⁵ or more, more preferably 10×10⁵ or more, still more preferably 15×10⁵ or more. In addition, the upper limit value of the weight average molecular weight is preferably 10×10⁶ or less, more preferably 8.0×10⁶ or less, still more preferably 5.0×10⁶ or less, and most preferably 3.0×10⁶ or less. When the molecular weight is within the above range, the strength of the obtained polyolefin microporous film is sufficient, and the meltdown temperature can be increased, which is preferable.

As will be described later, the polyolefin microporous film according to the embodiment of the present invention is preferably manufactured using a polyolefin resin solution in which the polyolefin resin used in the embodiment of the present invention is dissolved in a plasticizer by heating.

The high-density polyethylene, which is a polyolefin resin contained in the polyolefin resin solution, preferably has a weight average molecular weight (Mw) of 1.0×10⁴ or more and 1.0×10⁶ or less, more preferably 5.0×10⁴ or more and 3.5×10⁵ or less, still more preferably 1.0×10⁵ or more and 2.5×10⁵ or less, and particularly preferably 1.0×10⁵ or more and 2.0×10⁵ or less. When the weight average molecular weight is within the above range, an excessive crystal orientation in the plane is less likely to proceed during film formation, and a change in the crystal structure of the polyolefin microporous film can be easily controlled to an appropriate range, and therefore, the shutdown characteristics can be improved and the deterioration of the permeability can also be prevented. It is also preferable because the weight average molecular weight leads to an increase in the strength of the polyolefin microporous film.

The polyolefin other than polyethylene further contained in the polyolefin resin solution preferably has a weight average molecular weight of 5.0×10⁵ or more, more preferably 10×10⁵ or more, still more preferably 15×10⁵ or more. In addition, in terms of the upper limit, the weight average molecular weight is preferably 10×10⁶ or less, more preferably 8.0×10⁶ or less, still more preferably 5.0×10⁶ or less, and most preferably 3.0×10⁶ or less. When the molecular weight is 5.0×10⁵ or more, the strength of the obtained polyolefin microporous film is sufficient, which is preferable. It is preferable to use a raw material having a molecular weight of 10×10⁶ or less because the viscosity does not become too high during melt-kneading in the manufacturing process, and uniform kneading can be performed.

The melting point of the polyolefin other than polyethylene is preferably 150° C. or higher, more preferably 155° C. or higher, and still more preferably 160° C. or higher. When the melting point is within the range, the meltdown temperature can be increased, which is preferable.

A blending ratio of the polyolefin resin and the plasticizer is may be appropriately selected within a range that does not impair the molding processability, and the content of the polyolefin resin is 10% to 50% by mass based on the total of the polyolefin resin and the plasticizer being 100% by mass. When the content of the polyolefin resin is less than 10% by mass (when the content of the plasticizer is 90% by mass or more), during molding into a sheet shape, the amount of the swell and neck-in is large at the outlet of the die, the formability of the sheet is deteriorated, and the film-forming property is deteriorated. On the other hand, when the content of the polyolefin resin is more than 50% by mass (when the content of the plasticizer is 50% by mass or less), the shrinkage in the film thickness direction increases, and the molding processability also decreases.

In addition, the polyolefin microporous film according to the embodiment of the present invention may contain various additives such as an antioxidant, a heat stabilizer, an antistatic agent, an ultraviolet absorber, a blocking inhibitor, and a filler as long as the effects of the present invention are not impaired. In particular, an antioxidant is preferably added for the purpose of preventing oxidation degradation due to thermal history of the polyethylene resin. As the antioxidant, for example, it is preferable to use one or more kinds selected from 2,6-di-t-butyl-p-cresol (BHT: molecular weight of 220.4), 1,3,5-trimethyl-2,4,6-tris(3,5-di-t-butyl-4-hydroxybenzyl)benzene (for example, “Irganox” (registered trademark) 1330: molecular weight of 775.2, manufactured by BASF), tetrakis [methylene-3-(3,5-di-t-butyl-4-hydroxyphenyl)propionate] methane (for example, “Irganox” (registered trademark) 1010: molecular weight of 1177.7, manufactured by BASF), and the like. It is important to appropriately select the kind and the addition amount of the antioxidant or the heat stabilizer to adjust or enhance the characteristics of the microporous film.

The polyolefin microporous film according to the embodiment of the present invention is obtained by biaxial stretching using the above-described raw materials. Any of an inflation method, a simultaneous biaxial stretching method, and a sequential biaxial stretching method can be adopted as the biaxial stretching method. Among these, the simultaneous biaxial stretching method or the sequential biaxial stretching method is preferably adopted from the viewpoint of controlling film formation stability, thickness uniformity, and high rigidity and dimensional stability of the film.

Next, a method for manufacturing the polyolefin microporous film according to the embodiment of the present invention will be described, but the present invention is not necessarily limited thereto. The method for manufacturing the polyolefin microporous film according to the embodiment of the present invention includes the following steps (a) to (e).

(a) A polyolefin solution is prepared by kneading and dissolving a polymer material containing a polyolefin alone, a polyolefin mixture, a polyolefin solvent (plasticizer) mixture, an additive, and a polyolefin kneaded material.

(b) A dissolved material is extruded, molded into a sheet shape, and cooled and solidified.

(c) The obtained sheet is stretched by a roll method or a tenter method.

(d) Thereafter, the plasticizer is extracted from the obtained stretched film, and the film is dried.

(e) Subsequently, heat treatment, re-stretching, or heat fixing is performed.

Hereinafter, each step will be described.

(a) Preparation of Polyolefin Resin Solution

A polyolefin resin solution is prepared by heating and dissolving a polyolefin-based resin used in the embodiment of the present invention in a plasticizer. The plasticizer is not particularly limited as long as it is a solvent capable of sufficiently dissolving the polyolefin resin, but the solvent is preferably liquid at room temperature to enable stretching at a relatively high ratio. Examples of the solvent include aliphatic, cyclic aliphatic or aromatic hydrocarbons such as nonane, decane, decalin, paraxylene, undecane, dodecane and liquid paraffin, mineral oil fractions having boiling points corresponding to these hydrocarbons, and phthalic esters which are liquid at the room temperature such as dibutyl phthalate and dioctyl phthalate. In order to obtain a gel sheet having a liquid solvent in a stable content, it is preferable to use a nonvolatile liquid solvent such as liquid paraffin. Under a melt-kneading state, the liquid solvent may be mixed with a solvent which can be mixed with the polyolefin resin and is solid at the room temperature. Examples of such a solid solvent include stearyl alcohol, ceryl alcohol, and paraffin wax. However, when only the solid solvent is used, stretching unevenness and the like may occur.

The viscosity of the liquid solvent is preferably 20 cSt to 200 cSt at 40° C. When the viscosity at 40° C. is 20 cSt or more, the sheet obtained by extruding a polyolefin resin solution from a die is less likely to become non-uniform. On the other hand, when the viscosity is 200 cSt or less, the liquid solvent can be easily removed. The viscosity of the liquid solvent is the viscosity measured at 40° C. using an Ubbelohde viscometer.

When two or more kinds of polyethylenes are blended with the polyethylene-based resin used in the embodiment of the present invention, it is preferable to use ultra high molecular weight polyethylene having a weight average molecular weight of 1.0×10⁶ or more and less than 4.0×10⁶. By containing the ultra high molecular weight polyethylene, the pore size can be reduced and the heat resistance can be increased, and further, the strength and the elongation can be improved. The ultra high molecular weight polyethylene is not limited to a homopolymer of ethylene and may be a copolymer containing a small amount of other α-olefins. The α-olefins other than ethylene may be the same as those described above.

Further, since the main raw material or the raw material used for the purpose of lowering the shutdown temperature has a relatively small molecular weight, when the raw material is formed into a sheet shape, the swell and the neck are large at the outlet of the die, and the formability of the sheet tends to deteriorate. The addition of the ultra high molecular weight polyethylene as a secondary material increases the viscosity and strength of the sheet and increases the process stability, and thus it is preferable to add the ultra high molecular weight polyethylene. However, when the proportion of the ultra high molecular weight polyethylene is 50% by mass or more, the extrusion load increases and the extrusion moldability decreases, and thus the addition amount of the ultra high molecular weight polyethylene is preferably less than 50% by mass based on the total amount of the polyolefin resin.

(b) Formation of Extruded Product and Formation of Gel Sheet

The uniform melt-kneading of the polyolefin resin solution is not particularly limited, but is preferably performed in a twin-screw extruder when a high concentration polyolefin resin solution is desired to be prepared. If necessary, various additives such as an antioxidant may be added as long as the effects of the present invention are not impaired. In particular, an antioxidant is preferably added in order to prevent oxidation of the polyolefin resin.

Since the polyolefin microporous film according to the embodiment of the present invention is a single microporous film containing a polyethylene-based resin and a polyolefin (B) other than polyethylene, it is necessary to uniformly knead and extrude a plurality of raw materials having different melting points. When the kneading state is not uniform, the strength and the meltdown temperature of the microporous film may decrease, or variation in pore diameter may increase. For uniform kneading, in the first half of the extruder, it is preferable that the temperature is set to Tm1+30° C. or lower when the melting point of the raw material having the lowest melting point among the polyethylene-based resin and the polyolefin (B) to be used is Tm1, and the raw materials are uniformly mixed in a state before melting. Next, in the latter half of the extruder, the polyolefin resin solution is uniformly mixed at a temperature at which the polyethylene-based resin and the polyolefin (B) are completely melted. A melt-kneading temperature is preferably (Tm2−10° C.) to (Tm2+120° C.) when the melting point of the raw material having the highest melting point among the polyethylene-based resin and the polyolefin (B) to be used is Tm2. More preferably, the melt-kneading temperature is (Tm2+20° C.) to (Tm2+100° C.). Here, the melting point refers to a value measured by DSC based on JIS K7121 (1987) (the same applies hereinafter). For example, when a polyethylene-based resin and a polypropylene-based resin are used, the melt-kneading temperature is preferably in a range of 160° C. or lower in the first half of the extruder and 150° C. to 280° C. in the latter half of the extruder.

From the viewpoint of preventing deterioration of the resin, it is preferable that the melt-kneading temperature is low, but when the melt-kneading temperature is lower than the above-described temperature, an unmelted product is present in an extruded product extruded from a die, which may cause rupture and the like in a subsequent stretching step. When the melt-kneading temperature is higher than the above-described temperature, the thermal decomposition of the polyolefin resin becomes severe, and the physical properties, for example, strength, porosity, and the like of the microporous film to be obtained may deteriorate. In addition, the decomposition product precipitates on a chill roll, a roll in the stretching step, and the like and adheres to the sheet, which leads to deterioration of the appearance. Therefore, the melt-kneading temperature is preferably within the above range.

Next, a gel sheet is obtained by cooling the obtained extruded product, and a micro phase of the polyolefin resin separated by the solvent can be fixed by cooling. In the cooling step, the temperature of the gel sheet is preferably lowered to 10° C. to 50° C. This is because the final cooling temperature is preferably equal to or lower than the crystallization end temperature, and uniform stretching can be easily performed in the subsequent stretching by making a higher-order structure finer. Therefore, cooling is preferably performed at a rate of 30° C./min or more at least until the temperature is equal to or lower than the gelation temperature. When the cooling rate is less than 30° C./min, the degree of crystallization increases, and a gel sheet suitable for stretching is less likely to be obtained. In general, when the cooling rate is low, relatively large crystals are formed, and thus, the high-order structure of the gel sheet becomes coarse, and a gel structure forming the high-order structure also becomes large. On the other hand, when the cooling rate is high, since relatively small crystals are formed, the high-order structure of the gel sheet becomes dense, which leads to a high strength and a uniform pore diameter.

Examples of the cooling method include a method of bringing the obtained extruded product into direct contact with cold air, cooling water, or another cooling medium, a method of bringing the obtained extruded product into contact with a roll cooled with a refrigerant, and a method of using a casting drum or the like.

In addition, the polyolefin microporous film according to the embodiment of the present invention is preferably a single layer from the viewpoint of simplifying the process and reducing the film thickness, but the polyolefin microporous film is not limited to a single layer, and may be a laminate. The number of laminated layers is not particularly limited, and may be two or three or more. As described above, the laminated portion may contain, in addition to polyethylene, desired resins to the extent that the effects of the present invention are not impaired. As a method for forming the polyolefin microporous film into a laminate, a method in the related art can be used, and for example, there is a method in which desired resins are prepared as necessary, these resins are separately supplied to an extruder, melted at a desired temperature, merged in a polymer tube or a die, and extruded from a slit-shaped die at a desired thickness to form a laminate.

(c) Stretching Step

The obtained gel-like (including a laminated sheet) sheet is stretched. Examples of the stretching method to be used include uniaxial stretching in a sheet conveying method (MD direction) performed by a roll stretching machine, uniaxial stretching in a sheet transverse direction (TD direction) performed by a tenter, sequential biaxial stretching performed by a combination of a roll stretching machine and a tenter or a combination of a tenter and a tenter, and simultaneous biaxial stretching performed by a simultaneous biaxial tenter. The stretching ratio varies depending on the thickness of the gel sheet from the viewpoint of the uniformity of the film thickness, but it is preferable to stretch the gel sheet 5 times or more in any direction. The area magnification is preferably 25 times or more, more preferably 36 times or more, still more preferably 49 times or more, and most preferably 64 times or more. When the area magnification is less than 25 times, the stretching is insufficient and the uniformity of the film is likely to be impaired, and an excellent microporous film cannot be obtained also from the viewpoint of the strength. The area magnification is preferably 100 times or less. When the area magnification is increased, breakage is likely to occur during the manufacturing of the microporous film, and the productivity decreases. When the orientation progresses and the degree of crystallization increases, the melting point and the strength of the microporous film are improved. However, an increase in the degree of crystallization means a decrease in the amorphous portion, and the melting point and the shutdown temperature of the film increase.

The stretching temperature is preferably equal to or lower than the melting point of the gel sheet+10° C., and more preferably in the range of (crystal dispersion temperature Tcd of polyolefin resin) to (melting point of gel sheet+5° C.). Specifically, since the gel sheet has a crystal dispersion temperature of about 90° C. to 100° C. in the case of the polyethylene composition, the stretching temperature is preferably 90° C. to 125° C., and more preferably 90° C. to 120° C. The crystal dispersion temperature Tcd is determined based on the temperature characteristics of dynamic viscoelasticity measured according to ASTM D 4065. Alternatively, The crystal dispersion temperature Tcd may be determined from NMR. When the stretching temperature is less than 90° C., the pore opening is insufficient due to the low-temperature stretching, and thus, the uniformity of the film thickness is less likely to be obtained, and the porosity also decreases. When the stretching temperature is higher than 125° C., melting of the sheet occurs, and clogging of pores is likely to occur.

By the stretching as described above, cleavage occurs in the high-order structure formed in the gel sheet, the crystal phase is miniaturized, and a large number of fibrils are formed. Fibrils form a three-dimensionally irregularly connected network structure. The stretching improves the mechanical strength and expands the pores, which is suitable for a battery separator. In addition, the polyolefin resin is sufficiently plasticized and softened by performing stretching before removing the plasticizer, such that the cleavage of the high-order structure becomes smooth, and the crystal phase can be uniformly miniaturized. In addition, since the cleavage is facilitated, strain during stretching is less likely to remain, and the thermal shrinkage rate can be reduced as compared with the case where stretching is performed after removing the plasticizer.

(d) Plasticizer Extraction (Washing) and Drying Step

Next, the plasticizer (solvent) remaining in the gel sheet is removed using a washing solvent. Since the polyolefin resin phase and the solvent phase are separated from each other, a microporous film is obtained by removing the solvent. Examples of the washing solvent include saturated hydrocarbons such as pentane, hexane, and heptane, chlorinated hydrocarbons such as methylene chloride and carbon tetrachloride, ethers such as diethyl ether and dioxane, ketones such as methyl ethyl ketone, and chain fluorocarbons such as ethane trifluoride. These washing solvents have a low surface tension (for example, 24 mN/m or less at 25° C.). By using a washing solvent having a low surface tension, in a network structure for forming the micropores, shrinkage due to the surface tension of the air-liquid interface is prevented during drying after cleaning, and a microporous film having good porosity and permeability can be obtained. These washing solvents are appropriately selected according to the plasticizer, and used alone or as a mixture.

The washing method can be performed by a method of immersing the gel sheet in the washing solvent and extracting, a method of showering the gel sheet with the washing solvent, a method based on a combination thereof, and the like. The amount of the washing solvent used varies depending on the washing method, and is generally preferably 300 parts by mass or more based on 100 parts by mass of the gel sheet. The washing temperature may be 15° C. to 30° C., and if necessary, the washing solvent is heated to reach 80° C. or lower. At this time, from the viewpoint of enhancing the washing effect of the solvent, from the viewpoint of preventing the physical properties of the obtained polyolefin microporous film in the TD direction and/or the MD direction from becoming non-uniform, and from the viewpoint of improving the mechanical physical properties and the electrical physical properties of the polyolefin microporous film, the longer the time during which the gel sheet is immersed in the washing solvent, the more preferable. The washing as described above is preferably performed until the residual solvent in the gel sheet after washing, that is, in the polyolefin microporous film becomes less than 1% by mass.

Thereafter, in a drying step, the solvent in the polyolefin microporous film is dried and removed. The drying method is not particularly limited, and a method using a metal heating roll, a method using hot air, and the like can be selected. The drying temperature is preferably 40° C. to 100° C., and more preferably 40° C. to 80° C. When the drying is insufficient, the porosity of the polyolefin microporous film decreases in the subsequent heat fixing, and the permeability deteriorates.

(e) Heat Treatment/Re-Stretching/Heat Fixing Step

The dried polyolefin microporous film may be stretched (re-stretched) at least in a uniaxial direction. The re-stretching can be performed by a tenter method and the like in the same manner as the stretching described above while heating the microporous film. The re-stretching may be uniaxial stretching or biaxial stretching. In the case of multistage stretching, the re-stretching is performed by combining simultaneous biaxial stretching or/and sequential stretching.

The temperature of the re-stretching is preferably equal to or lower than the melting point of the polyolefin composition, and more preferably in the range of (Tcd—20° C.) to the melting point. Specifically, the temperature is preferably 70° C. to 135° C., and more preferably 110° C. to 132° C. The temperature is most preferably 120° C. to 130° C.

In the case of the uniaxial stretching, the re-stretching ratio is preferably 1.01 to 1.6 times, and in particular, the ratio in the TD direction is preferably 1.1 to 1.6 times, and more preferably 1.2 to 1.4 times. In the case of the biaxial stretching, the re-stretching ratio is preferably 1.01 to 1.6 times in each of the MD direction and the TD direction. The re-stretching ratio may be different between the MD direction and the TD direction. When stretching is performed within the range described above, the porosity and the permeability can be increased, but when stretching is performed with a ratio of 1.6 or more, the orientation proceeds, the melting point of the film increases, and the shutdown temperature increases. From the viewpoint of the thermal shrinkage ratio and wrinkles and slack, the relaxation rate from the maximum re-stretching ratio is preferably 0.9 or less, and more preferably 0.8 or less.

It is preferable to fix the width of the film to a constant value and perform heat fixing regardless of whether or not re-stretching is performed. By performing heat fixing, strain stress generated by stretching can be relaxed, and the peak half width of DSC becomes sharp. The temperature of the heat fixing is preferably 70° C. to 135° C., and more preferably 110° C. to 132° C. The temperature is most preferably 115° C. to 130° C. The time for heat fixing is not particularly limited, but is 1 second to 15 minutes. Within this range, pore clogging due to melting of the polyolefin resin can be prevented while sufficiently relaxing the strain stress.

(f) Other Steps

Further, the microporous film may be subjected to a hydrophilization treatment depending on applications. The hydrophilization treatment can be performed by a monomer graft, a surfactant treatment, corona discharge, and the like. The monomer graft is preferably performed after a crosslinking treatment. The polyolefin microporous film is preferably subjected to a crosslinking treatment by irradiation with ionizing radiation such as α-rays, β-rays, γ-rays, and an electron beam. In the case of electron beam irradiation, the electron dose is preferably 0.1 to 100 Mrad, and the acceleration voltage is preferably 100 to 300 kV. The crosslinking treatment increases the meltdown temperature of the polyolefin microporous film.

In the case of the surfactant treatment, any of a nonionic surfactant, a cationic surfactant, an anionic surfactant, and an amphoteric surfactant can be used, and a nonionic surfactant is preferred. The multilayer microporous film is immersed in a solution obtained by dissolving a surfactant in water or a lower alcohol such as methanol, ethanol and isopropyl alcohol, or the multilayer microporous film is coated with the solution by a doctor blade method.

Surface coatings of a porous body such as a fluorine-based resin porous body such as polyvinylidene fluoride or polytetrafluoroethylene, polyimide, polyphenylene sulfide and the like or inorganic coatings of ceramics may be applied to the polyolefin microporous film for the purpose of improving meltdown characteristics and heat resistance when used as a battery separator.

The polyolefin microporous film according to the embodiment of the present invention is also preferably a laminate in which a coating layer is provided on at least one surface.

The polyolefin microporous film obtained as described above can be used in various applications such as a filter, a separator for a fuel cell, and a separator for a capacitor. In particular, when the polyolefin microporous film is used as a battery separator, the battery separator not only has a low shutdown characteristic and a high meltdown characteristic but also has a high strength despite the thin film, that is, both a high safety function and a high output characteristic are achieved, and therefore, the polyolefin microporous film can be preferably used as a battery separator for a secondary battery requiring a high energy density, a high capacity, and high output for an electric vehicle and the like.

The present invention also relates to a battery using the polyolefin microporous film or laminate according to the embodiment of the present invention.

### EXAMPLES

Hereinafter, the present invention will be described in detail with reference to Examples. The characteristics were measured and evaluated by the following methods.

1. Measurement of Molecular Weight Distribution of Polyolefin

Measurement of a molecular weight distribution (measurement of weight average molecular weight, molecular weight distribution, content of a predetermined component, and the like) of the polyolefin was measured by high-temperature gel permeation chromatography (GPC). Measurement conditions were as follows.

Apparatus: high-temperature GPC apparatus (apparatus No. HT-GPC, manufactured by Polymer Laboratories, PL-220)

Detector: differential refractive index detector RI

Guard column: Shodex G-HT

Column: Shodex HT806M (two columns) (φ7.8 mm×30 cm, manufactured by Showa Denko)

Solvent: 1,2,4-trichlorobenzene (TCB, manufactured by Wako Pure Chemical Industries, Ltd.) (0.1% BHT added)

Flow rate: 1.0 mL/min

Column temperature: 145° C.

Sample preparation: 5 mL of a measurement solvent was added to 5 mg of a sample, the mixture was heated and stirred at 160° C. to 170° C. for about 30 minutes, and the obtained solution was filtered through a metal filter (pore diameter: 0.5 um).

Injection amount: 0.200 mL

Standard sample: monodisperse polystyrene (manufactured by Tosoh Corporation) (PS)

Data processing: GPC data processing system manufactured by TRC

Thereafter, the obtained Mw and Mn were converted into polyethylene (PE). The conversion formula is as follows.

Mw (PE conversion)=Mw (PS conversion measurement value)×0.468

Mn (PE conversion)=Mn (PS conversion measurement value)×0.468

2. Film Thickness

The film thickness at five points in the range of 50 mm×50 mm of the polyolefin microporous film was measured by a contact thickness meter, which is LITEMATIC VL-50 manufactured by Mitutoyo Corporation (10.5 mmφ ultrahard sphere surface meter, measurement load: 0.01 N), and the average value was defined as the film thickness (μm).

3. Air Permeability Resistance

The polyolefin microporous film having a film thickness T₁ (μm) was measured for air permeability (sec/100 cm³) in accordance with JIS P-8117 under an atmosphere of 25° C. with an Oken type air permeability meter (EGO-1T, manufactured by Asahi Seiko Co., Ltd.). In addition, the air permeability in terms of 10 μm (sec/100 cm³) obtained by converting to the film thickness of 10 μm was calculated by the following formula.

air permeability in terms of 10 μm (sec/100 cm³)=air permeability (sec/100 cm³)×10 (μm)/film thickness (μm) of polyolefin microporous film Formula:

4. Puncture Strength

The puncture strength was measured in accordance with JIS Z 1707 (2019) except that the test speed was 2 mm/sec. By using a force gauge (DS2-20N manufactured by Imada Co., Ltd.), the maximum load (N) when the polyolefin microporous film was pierced under an atmosphere of 25° C. with a needle having a spherical tip (curvature radius R: 0.5 mm) and a diameter of 1.0 mm was measured, and the puncture strength when the film thickness was 10 μm was calculated based on the following formula.

puncture strength in terms of 10 μm (N)=maximum load (N)×10 (μm)/film thickness (μm) of polyolefin microporous film Formula:

5. Porosity (%)

A 50 mm×50 mm square sample was cut out from the polyolefin microporous film, and the volume (cm³) and the mass (g) thereof at the room temperature of 25° C. were measured. From these values and the film density (g/cm³), the porosity of the polyolefin microporous film was calculated by the following formula.

Porosity (%)=(volume−mass/film density)/volume×100

The porosity was calculated on the assumption that the film density was a constant value of 0.99 g/cm³.

6. Tensile Strength and Tensile Elongation

The tensile strength M_{MD}, the tensile strength MID, the tensile elongation in the MD direction, and the tensile elongation in the TD direction were measured using a strip test piece having a width of 30 mm at a rate of 100 mm/min in accordance with ASTM D882.

7. Shutdown Temperature

While the polyolefin microporous film was heated at a temperature rise rate of 5° C./min, the air permeability resistance was measured by an air permeability meter (EGO-1T, manufactured by Asahi Seiko Co., Ltd.), and a temperature at which the air permeability resistance reached 1×10⁵ sec/100 cm³ Air, which was the detection limit, was determined as the shutdown temperature (° C.).

A measurement cell was constituted by an aluminum block, and had a structure having a thermocouple immediately below the polyolefin microporous film, and a sample was cut into a 5 cm×5 cm square and subjected to temperature rise measurement while the periphery thereof was fixed with an O-ring.

8. Meltdown Temperature

A 50 mm square microporous film is sandwiched between a pair of metal block frames each having a hole with a diameter of 12 mm, and a ball made of tungsten carbide and having a diameter of 10 mm is disposed on the microporous film. The microporous film is disposed so as to have a plane in the horizontal direction. The temperature is increased from 30° C. at a rate of 5° C./min. A temperature at which the microporous film was broken by the sphere was measured and defined as the meltdown temperature (MD temperature).

9. DSC Measurement

The melting point and the half width are determined by a differential scanning calorimeter (DSC). This DSC was performed using MDSC 2920 or Q1000 Tzero-DSC of TA Instruments, the temperature was raised from 30° C. to 230° C. at a rate of 10° C./min based on JIS K7121, and the temperature at the maximum value of the obtained melting peak (peak temperature) was evaluated. The peak temperature in the region of lower than 150° C. was defined as P1, and the peak temperature at 150° C. or higher was defined as P2.

As for the half width, the value of T₂−T₁ was calculated when the temperatures at which the heat generation amount was Q_{1/2}, which was 0.5 times the maximum heat generation amount Q in the region of lower than 150° C., were T₁ and T₂ (T₁<T₂), respectively. In the case where there are two or more maximum values in the region of lower than 150° C., and thus there are three or more temperatures at which the heat generation amount was Q_{1/2}, a half width is calculated with a minimum temperature of the corresponding temperature as T₁ and a maximum temperature as T₂.

10. Maximum Pore Diameter and Average Pore Diameter

By using a Perm Porometer (CFP-1500A, manufactured by PMI), the maximum pore diameter and the average pore diameter were measured in an order of Dry-up and Wet-up. In the Wet-up, a pressure was applied to a porous polyolefin film sufficiently immersed in Galwick (trade name) manufactured by PMI having a surface tension of 1.59×10⁻² N/m, and the pore diameter converted from the pressure at which air began to penetrate was defined as the maximum pore diameter.

Regarding the average diameter, the pore diameter was converted from the pressure at the intersection of a curve showing the slope of ½ of the pressure and flow rate curves in Dry-up measurement and a curve in Wet-up measurement. For the conversion of the pressure and the pore diameter, the following formula was used.

d=C·γ/P

In the above formula, “d (μm)” is a pore diameter of the porous polyolefin film, “γ (mN/m)” is a surface tension of the liquid, “P (Pa)” is a pressure, and “C” is a constant determined by a wetting tension, a contact angle, and the like of the immersion liquid.

Hereinafter, the present invention will be described in detail with reference to Examples, but the present invention is not limited to these Examples.

### Example 1

A polyolefin composition was obtained by mixing 54.6 parts by mass of branched high-density polyethylene (branched HDPE) (weight average molecular weight (Mw) 1.8×10⁵, melting point 133° C.), 23.4 parts by mass of ultra high molecular weight polyethylene (UHPE) (Mw 2.0×10⁶, melting point 133° C.), and 22.0 parts by mass of polypropylene (PP) (Mw 1.1×10⁶, melting point 165° C.). To 28.5% by mass of the polyolefin composition, 71.5% by mass of liquid paraffin was added, and further, based on the mass of the polyolefin in the mixture, 0.5% by mass of 2,6-di-t-butyl-p-cresol and 0.7% by mass of tetrakis[methylene-3-(3,5-di-t-butyl-4-hydroxyphenyl)-propionate]methane were added as an antioxidant and mixed with the mixture to prepare a polyethylene resin solution.

The obtained polyethylene resin solution was put into a twin-screw extruder, kneaded at 150° C. in the first half of the extruder and at 180° C. in the latter half of the extruder, supplied to a T-die, extruded into a sheet shape, and then the extruded product was cooled by a cooling roll controlled to 15° C. to form a gel sheet.

The obtained gel sheet was stretched 7 times by a film stretcher in the machine direction at 115° C. while holding four sides by clips, and then stretched 7 times (sequential stretching (area magnification 49 times)) in the transverse direction, the sheet width was fixed in the film stretcher, and the sheet was held at a temperature of 115° C. for 10 seconds, and then was taken out.

Next, the stretched gel sheet was fixed to a metal frame and was immersed into a methylene chloride bath in a washing tank, liquid paraffin was removed, and then drying was performed, thereby obtaining a polyolefin microporous film.

Finally, the polyolefin microporous film fixed to the metal frame was introduced into a hot air oven and subjected to a heat fixing treatment at 120° C. for 10 minutes.

The raw material characteristics of the polyolefin microporous film, the film forming conditions, and the evaluation results of the microporous film are shown in Table 1.

### Example 2

A polyolefin microporous film was obtained in the same manner as in Example 1, except that branched HDPE was 59.5 parts by mass, UHPE was 25.5 parts by mass, and PP was 15.0 parts by mass.

### Example 3

A polyolefin microporous film was obtained in the same manner as in Example 1, except that UHPE was not used, 60% by mass of liquid paraffin was added to 40% by mass of a polyolefin composition formed of 80.0 parts by mass of branched HDPE and 20.0 parts by mass of PP, simultaneous biaxial stretching was performed, and a heat fixing temperature was set to 125° C.

### Example 4

A polyolefin microporous film was obtained in the same manner as in Example 3, except that a stretching ratio was 10 times in the machine direction and 10 times in the transverse direction.

### Example 5

A polyolefin microporous film was obtained in the same manner as in Example 1, except that a stretching method was simultaneous biaxial stretching and a ratio was 5 times in the machine direction and 5 times in the transverse direction.

### Example 6

A polyolefin microporous film was obtained in the same manner as in Example 1, except that branched HDPE was 62.5 parts by mass, UHPE was 30.0 parts by mass, and PP was 7.5 parts by mass.

### Example 7

A polyolefin composition was obtained by mixing 20.0 parts by mass of branched high-density polyethylene (branched HDPE) (weight average molecular weight (Mw) 9.0×10⁴, melting point 131° C.), 70.0 parts by mass of ultra high molecular weight polyethylene (UHPE) (Mw 1.0×10⁶, melting point 136° C.), and 10.0 parts by mass of polypropylene (PP) (Mw 1.1×10⁶, melting point 165° C.). To 23% by mass of the polyolefin composition, 77% by mass of liquid paraffin was added, and further, based on the mass of the polyolefin in the mixture, 0.5% by mass of 2,6-di-t-butyl-p-cresol and 0.7% by mass of tetrakis[methylene-3-(3,5-di-t-butyl-4-hydroxyphenyl)-propionate]methane were added as an antioxidant and mixed with the mixture to prepare a polyethylene resin solution.

The obtained polyethylene resin solution was put into a twin-screw extruder, kneaded at 180° C., supplied to a T-die, and extruded into a sheet shape, and the extruded product was cooled by a cooling roll controlled to 15° C. to form a gel sheet.

The obtained gel sheet was stretched 5 times by a film stretcher in the machine direction at 115° C. while holding four sides by clips, and then stretched 5 times (simultaneous stretching (area magnification 25 times)) in the transverse direction, the sheet width was fixed in the film stretcher, and the sheet was held at a temperature of 115° C. for 10 seconds, and then was taken out.

Next, the stretched gel sheet was fixed to a metal frame and was immersed into a methylene chloride bath in a washing tank, liquid paraffin was removed, and then drying was performed, thereby obtaining a polyolefin microporous film.

Finally, the polyolefin microporous film fixed to the metal frame was introduced into a hot air oven and subjected to a heat fixing treatment at 130° C. for 10 minutes.

### Example 8

A polyolefin microporous film was obtained in the same manner as in Example 7, except that branched HDPE was 20.0 parts by mass, UHPE was 75.0 parts by mass, and PP was 5.0 parts by mass.

### Comparative Example 1

A polyolefin microporous film was obtained in the same manner as in Example 1, except that linear HDPE (Mw 3.0×10⁵, melting point 136° C.) was used instead of branched HDPE, and a temperature of a twin-screw extruder was kept constant at 180° C.

### Comparative Example 2

A polyolefin microporous film was obtained in the same manner as in Comparative Example 1, except that a stretching method was simultaneous biaxial stretching and a ratio was 5 times in the machine direction and 5 times in the transverse direction.

### Comparative Example 3

A polyolefin microporous film was obtained in the same manner as in Example 3, except that PP was not used, 75.0% by mass of liquid paraffin was added to 25% by mass of a polyolefin composition formed of 40.0 parts by mass of branched HDPE and 60.0 parts by mass of UHPE, a stretching temperature was set to 110° C., and a heat fixing temperature was set to 115° C.

### Comparative Example 4

A polyolefin microporous film was obtained in the same manner as in Example 6, except that linear HDPE (Mw 3.0×10⁵, melting point 136° C.) was used instead of branched HDPE, a temperature of a twin-screw extruder was constant at 180° C., and a heat fixing temperature was 120° C.

### Comparative Example 5

A polyolefin microporous film was obtained in the same manner as in Comparative Example 2, except that 70% by mass of liquid paraffin was added to 30.0% by mass of a polyolefin composition formed of 80.0 parts by mass of linear HDPE and 20.0 parts by mass of PP, a stretching ratio was set to 8 times in the machine direction and 8 times in the transverse direction, and a heat fixing temperature was set to 125° C.

The evaluation results of the obtained polyolefin microporous films are as shown in Tables 1 and 2.

“Linear HDPE” shown in Tables 1 and 2 represents linear high-density polyethylene.

TABLE 1

| | | | Example | Example | Example | Example | Example |
|---|---|---|---|---|---|---|---|
| | | | 1 | 2 | 3 | 4 | 5 |
| Film | Branched HDPE | Mw | 180,000 | 180,000 | 180,000 | 180,000 | 180,000 |
| forming | | Parts by mass | 54.6 | 59.5 | 80.0 | 80.0 | 54.6 |
| condition | | Melting point ° C. | 133 | 133 | 133 | 133 | 133 |
| | Linear HDPE | Mw | — | — | — | — | — |
| | | Parts by mass | — | — | — | — | — |
| | | Melting point ° C. | — | — | — | — | — |
| | UHPE | Mw | 2,000,000 | 2,000,000 | — | — | 2,000,000 |
| | | Parts by mass | 23.4 | 25.5 | — | — | 23.4 |
| | | Melting point ° C. | 133 | 133 | — | — | 133 |
| | PP | Mw | 1,100,000 | 1,100,000 | 1,100,000 | 1,100,000 | 1,100,000 |
| | | Parts by mass | 22.0 | 15 | 20.0 | 20.0 | 22.0 |
| | | Melting point ° C. | 165 | 165 | 165 | 165 | 165 |
| | Resin concentration | % by mass | 28.5 | 28.5 | 40 | 40 | 28.5 |
| | Stretching temperature | ° C. | 115 | 115 | 115 | 115 | 115 |
| | Stretching method | | Sequential | Sequential | Simultaneous | Simultaneous | Simultaneous |
| | Stretching ratio | | 7 × 7 | 7 × 7 | 7 × 7 | 10 × 10 | 5 × 5 |
| | Heat fixing temperature | ° C. | 120 | 120 | 125 | 125 | 120 |
| | Heat fixing time | min | 10 | 10 | 10 | 10 | 10 |
| Film | Film thickness | μm | 5 | 5.3 | 9.9 | 5.8 | 8.8 |
| physical | Porosity | % | 33 | 34.8 | 22.2 | 25.8 | 25.0 |
| property | Puncture strength | N | 4.4 | 4.1 | 2.9 | 3.8 | 3.2 |
| | in terms of 10 μm | | | | | | |
| | Air permeability resistance | sec/100 cm³ | 484 | 353.5 | 1010 | 1076 | 1270 |
| | in terms of 10 μm | | | | | | |
| | Tensile strength M_{MD} | MPa | 183 | 184 | 132 | 174 | 148 |
| | Tensile strength M_{TD} | MPa | 160 | 167 | 119 | 176 | 115 |
| | Tensile elongation MD | % | 56 | 71 | 92 | 75 | 112 |
| | Tensile elongation TD | % | 68 | 79 | 91 | 72 | 154 |
| | SD temperature | ° C. | 129.8 | 130.9 | 130.9 | 132.0 | 125.8 |
| | MD temperature | ° C. | 169.2 | 169.1 | 168.0 | 163.0 | 171.9 |
| | DSC peak temperature | ° C. | 133.7 | 134.0 | 133.5 | 136.5 | 132.3 |
| | P1 at lower than 150° C. | | | | | | |
| | DSC peak temperature | ° C. | 166.0 | 165.2 | 166.0 | 168.0 | 165.3 |
| | P2 at 150° C. or higher | | | | | | |
| | DSC half width | ° C. | 9.0 | 9.0 | 8.6 | 7.2 | 9.4 |
| | Average pore diameter | nm | 15.1 | 17.8 | 17.5 | 18.0 | 14.5 |
| | Maximum pore diameter | nm | 24.3 | 27.0 | 25.6 | 26.0 | 23.5 |

| | | | Example | Example | Example |
|---|---|---|---|---|---|
| | | | 6 | 7 | 8 |
| Film | Branched HDPE | Mw | 180,000 | 90,000 | 90,000 |
| forming | | Parts by mass | 62.5 | 20.0 | 20.0 |
| condition | | Melting point ° C. | 133 | 131 | 131 |
| | Linear HDPE | Mw | — | — | — |
| | | Parts by mass | — | — | — |
| | | Melting point ° C. | — | — | — |
| | UHPE | Mw | 2,000,000 | 1,000,000 | 1,000,000 |
| | | Parts by mass | 30.0 | 70.0 | 75.0 |
| | | Melting point ° C. | 133 | 136 | 136 |
| | PP | Mw | 1,100,000 | 1,100,000 | 1,100,000 |
| | | Parts by mass | 7.5 | 10.0 | 5.0 |
| | | Melting point ° C. | 165 | 165 | 165 |
| | Resin concentration | % by mass | 28.5 | 23 | 23 |
| | Stretching temperature | ° C. | 115 | 115 | 115 |
| | Stretching method | | Sequential | Simultaneous | Simultaneous |
| | Stretching ratio | | 7 × 7 | 5 × 5 | 5 × 5 |
| | Heat fixing temperature | ° C. | 120 | 130 | 130 |
| | Heat fixing time | min | 10 | 10 | 10 |
| Film | Film thickness | μm | 5.9 | 19.5 | 21 |
| physical | Porosity | % | 42.2 | 28.4 | 34.9 |
| property | Puncture strength | N | 3.7 | 3 | 3.1 |
| | in terms of 10 μm | | | | |
| | Air permeability resistance | sec/100 cm³ | 199 | 542 | 260 |
| | in terms of 10 μm | | | | |
| | Tensile strength M_{MD} | MPa | 164 | 158 | 159 |
| | Tensile strength M_{TD} | MPa | 160 | 148 | 161 |
| | Tensile elongation MD | % | 62 | 165 | 165 |
| | Tensile elongation TD | % | 85 | 200 | 173 |
| | SD temperature | ° C. | 132.1 | 132.3 | 136.7 |
| | MD temperature | ° C. | 151.1 | 176.7 | 151.7 |
| | DSC peak temperature | ° C. | 134.3 | 137.4 | 137.9 |
| | P1 at lower than 150° C. | | | | |
| | DSC peak temperature | ° C. | 163.9 | 163.4 | 162.5 |
| | P2 at 150° C. or higher | | | | |
| | DSC half width | ° C. | 9.3 | 9.1 | 9.9 |
| | Average pore diameter | nm | 22.0 | 28.4 | 24.7 |
| | Maximum pore diameter | nm | 30.7 | 52 | 50.8 |

TABLE 2

| | | | Comparative | Comparative | Comparative | Comparative | Comparative |
|---|---|---|---|---|---|---|---|
| | | | Example 1 | Example 2 | Example 3 | Example 4 | Example 5 |
| Film | Branched HDPE | Mw | — | — | 180,000 | — | — |
| forming | | Parts by mass | — | — | 40.0 | — | — |
| condition | | Melting point ° C. | — | — | 133 | — | — |
| | Linear HDPE | Mw | 300,000 | 300,000 | — | 300,000 | 300,000 |
| | | Parts by mass | 54.6 | 54.6 | — | 62.5 | 80.0 |
| | | Melting point ° C. | 136 | 136 | — | 136 | 136 |
| | UHPE | Mw | 2,000,000 | 2,000,000 | 2,000,000 | 2,000,000 | — |
| | | Parts by mass | 23.4 | 23.4 | 60.0 | 30.0 | — |
| | | Melting point ° C. | 133 | 133 | 133 | 133 | — |
| | PP | Mw | 1,100,000 | 1,100,000 | — | 1,100,000 | 1,100,000 |
| | | Parts by mass | 22.0 | 22.0 | — | 7.5 | 20.0 |
| | | Melting point ° C. | 165 | 165 | — | 165 | 165.0 |
| | Resin concentration | % by mass | 28.5 | 28.5 | 25 | 28.5 | 30 |
| | Stretching temperature | ° C. | 115 | 115 | 110 | 115 | 115 |
| | Stretching method | | Sequential | Simultaneous | Simultaneous | Sequential | Simultaneous |
| | Stretching ratio | | 7 × 7 | 5 × 5 | 7 × 7 | 7 × 7 | 8 × 8 |
| | Heat fixing temperature | ° C. | 120 | 120 | 115 | 120 | 125 |
| | Heat fixing time | min | 10 | 10 | 10 | 10 | 10 |
| Film | Film thickness | μm | 6.1 | 10.6 | 11.9 | 6.6 | 9.5 |
| physical | Porosity | % | 44.9 | 35.5 | 44 | 45.4 | 41.3 |
| property | Puncture strength in terms | N | 3.9 | 2.8 | 3.6 | 4.1 | 6.2 |
| | of 10 μm | | | | | | |
| | Air permeability resistance | sec/100 cm³ | 231 | 393 | 192 | 164 | 226 |
| | in terms of 10 μm | | | | | | |
| | Tensile strength M_{MD} | MPa | 165 | 151 | 170 | 180 | 220 |
| | Tensile strength M_{TD} | MPa | 149 | 94 | 162 | 178 | 210 |
| | Tensile elongation MD | % | 47 | 141 | 97 | 65 | 50 |
| | Tensile elongation TD | % | 88 | 134 | 105 | 85 | 46 |
| | SD temperature | ° C. | 135.7 | 133.5 | 130.7 | 137.3 | 136.9 |
| | MD temperature | ° C. | 178.7 | 173.9 | 149.2 | 151.0 | 174.2 |
| | DSC peak temperature P1 | ° C. | 137.3 | 135.7 | 134.0 | 137.3 | 136.8 |
| | at lower than 150° C. | | | | | | |
| | DSC peak temperature P2 | ° C. | 166.0 | 164.8 | — | 163.3 | 165.9 |
| | at 150° C. or higher | | | | | | |
| | DSC half width | ° C. | 12.1 | 10.1 | 11.2 | 11.6 | 10.7 |
| | Average pore diameter | nm | 23.6 | 15.8 | 17.0 | 23.8 | 18.0 |
| | Maximum pore diameter | nm | 34.4 | 33.1 | 41.7 | 34.1 | 35.2 |

### INDUSTRIAL APPLICABILITY

A polyolefin microporous film of the present invention has high safety and excellent output characteristics with low shutdown characteristics and high meltdown characteristics when used as a battery separator, while having a high strength. Therefore, the polyolefin microporous film can be suitably used as a battery separator or a laminate for a battery and a secondary battery requiring a high energy density, a high capacity, and high output for an electric vehicle and the like.

Although the present invention has been described in detail using specific embodiments, it will be apparent to those skilled in the art that various modifications and variations are possible without departing from the spirit and scope of the present invention.

The present application is based on Japanese Patent Application No. 2019-152105 filed on Aug. 22, 2019, the content of which is incorporated herein by reference.

1. A polyolefin microporous film comprising: a polyethylene-based resin; and
a polyolefin (B) other than polyethylene, wherein:
the polyolefin microporous film has peaks at temperatures of lower than 150° C. and 150° C. or higher respectively in a differential scanning calorimeter (DSC);
a half width of the peak at lower than 150° C. is 10° C. or lower; and
a puncture strength in terms of 10 μm is 2.0 N or more.

2. The polyolefin microporous film according to claim 1, wherein a temperature of the peak at lower than 150° C. is 135° C. or lower.

3. The polyolefin microporous film according to claim 1, wherein the polyolefin microporous film is a single layer.

4. The polyolefin microporous film according to claim 1, wherein a content of the polyolefin (B) other than polyethylene is 10% by mass or more.

5. The polyolefin microporous film according to claim 1, wherein the polyolefin (B) other than polyethylene is a polypropylene-based resin.

6. The polyolefin microporous film according to claim 1, wherein a shutdown temperature is 135° C. or lower.

7. The polyolefin microporous film according to claim 1, wherein a meltdown temperature is 160° C. or higher.

8. The polyolefin microporous film according to claim 1, wherein the polyolefin microporous film has a film thickness of 10 μm or less.

9. The polyolefin microporous film according to claim 1, wherein the polyolefin microporous film has a peak at 120° C. or higher in the differential scanning calorimeter (DSC).

10. A laminate, wherein a coating layer is provided on at least one surface of the polyolefin microporous film according to claim 1.

11. A battery using the polyolefin microporous film according to claim 1.

12. A battery using the laminate according to claim 10.
